(19) United States
(12) Patent Application Publication
(10) Pub. No.: US 2013/0232158 A1
(43) Pub. Date: Sep. 5, 2013

(54) DATA SUBSCRIPTION

(71) Applicants: Dag Heggelund, Houston, TX (US); Paul Galinski, Sugar Land, TX (US)

(72) Inventors: Dag Heggelund, Houston, TX (US); Paul Galinski, Sugar Land, TX (US)

(21) Appl. No.: 13/617,376

(22) Filed: Sep. 14, 2012

Related U.S. Application Data
(63) Continuation-in-part of application No. 12/900,048, filed on Oct. 7, 2010.
(60) Provisional application No. 61/324,908, filed on Apr. 16, 2010.

(51) Int. Cl. G06F 17/30

(52) U.S. Cl. CPC G06F 17/30345
USPC 707/756

(57) ABSTRACT

A method for managing oil field data based on one or more subscription elements. The method includes receiving the subscription elements having an area of interest, one or more data types and one or more dataset requirements. The area of interest includes one or more geographical properties that correspond to the oil field data, and the dataset requirements define how the oil field data is to be presented. The method further comprises identifying the oil field data that corresponds to the area of interest and the data type, transforming the identified oil data to one or more formats based on the dataset requirements, and outputting the transformed oil field data.

### RELATED APPLICATIONS

This application claims the benefit of and priority to U.S. patent application Ser. No. 12/900,048 filed Oct. 7, 2010, title DATA SUBSCRIPTION, which in turn claims the benefit of and priority to U.S. provisional patent application Ser. No. 61/324,908 filed Apr. 16, 2010, titled SMART DATA OBJECTS AND DATA SUBSCRIPTION. Each of the above applications is incorporated herein by reference.

### BACKGROUND

1. Field of the Invention

Implementations of various technologies described herein generally relate to techniques for managing oil field data and, more particularly, to techniques for receiving and outputting oil field data according to a subscription elements.

2. Description of the Related Art

The following descriptions and examples are not admitted to be prior art by virtue of their inclusion within this section.

The amount of oil field data, or exploration and production data, available to exploration geoscientists and Exploration and Production (E&P) professionals is enormous. Most of the exploration and production data is stored in unstructured databases. As a result, the database management system for the exploration and production data is inefficient, and it becomes increasingly difficult for a user to locate relevant exploration and production data in these unstructured databases. Currently, most database management systems “push” the exploration and production data to its recipients. That is, the systems transfer all of the exploration and production data from the databases to computer application operated by the exploration and production users. The transfer is termed “push” because the transfer is initiated by the sender. Generally, the sender does not know what users require; instead, the sender sends all of the available exploration and production data to the user even though the user may not be interested in all of the available exploration and production data. By pushing all of the available exploration and production data, database management processing time and energy are being wasted on irrelevant exploration and production data. Further, even if the pushed exploration and production data is relevant to the user, the exploration and production data is often in an un-useable format for the user. Therefore, much of the pushed exploration and production data needs to be transformed into a useable format which is generally accomplished using export/import workflows that are heavily dependent on highly skilled workers. Additionally, by pushing all of the available exploration and production data, the user may receive multiple versions of the same exploration and production data that exist on different applications and databases.

With the addition of even more exploration and production data to the digital universe, the bar for information management (IM) has been raised significantly. Today, IM is expected to manage more complex data type, manage larger data volumes, enable real-time collaboration, and enable shorter cycle times. Conventional methodologies and tools were not designed for this volume of data. As a result, the conventional methodologies and tools leave the end users with an enormous amount of exploration and production data to filter through. Therefore, there is a need for a more efficient method for sending exploration and production data to its recipients.

### SUMMARY

Described herein are implementations of various techniques for sending exploration and production data based on data subscription elements. In one implementation, a method for sending exploration and production data based on data subscription elements may include receiving the subscription elements having an area of interest, one or more data types and one or more dataset requirements. The area of interest may be described as having one or more geographical properties that correspond to the oil field data, and the dataset requirements may define how the oil field data is to be presented. After receiving the subscription elements, the method may send the subscription elements to a database engine. The method may then receive the oil field data from the database engine such that the oil field data corresponds to the subscription elements.

In another implementation, the method for sending exploration and production data based on data subscription elements may include receiving the subscription elements having an area of interest, one or more data types and one or more dataset requirements. The method may then include identifying the oil field data that corresponds to the area of interest and the data types, and transforming the identified oil field data to one or more formats based on the dataset requirements. After identifying the oil field data, the method may include sending the transformed oil field data.

In yet another implementation, the method for sending exploration and production data based on data subscription elements may include receiving the subscription elements having an area of interest, one or more data types and one or more dataset requirements. The method may then send the subscription elements and one or more conditions to a database engine. The conditions may define when the database engine should send the oil field data. After sending the subscription elements and the conditions, the method may receive the oil field data from the database engine such that the oil field data corresponds to the subscription elements and the conditions.

The claimed subject matter is not limited to implementations that solve any or all of the noted disadvantages. Further, the summary section is provided to introduce a selection of concepts in a simplified form that are further described below in the detailed description section. The summary section is not intended to identify key or essential features of the claimed subject matter, nor is it intended to be used to limit the scope of the claimed subject matter.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a schematic diagram of a database management system in accordance with implementations of various techniques described herein.

FIG. 2 illustrates a flow diagram of a method for receiving exploration and production data based on data subscription elements in accordance with implementations of various techniques described herein.

FIG. 3 illustrates a flow diagram of a method for outputting or otherwise sending exploration and production data based on data subscription elements in accordance with implementations of various techniques described herein.

FIG. 4 illustrates a computer network into which implementations of various technologies described herein may be implemented.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

The following provides a brief description of various technologies and techniques for receiving exploration and production data based on data subscription elements. In one implementation, a computer application may receive data subscription elements (i.e., data pull request) that include an area of interest, a data set description and a data set requirement from a user. The area of interest may describe geographical properties of data, the data set description may describe the type of data requested by the user, and the data set requirement may describe the manner in which the data should be prepared (i.e., format, units) for the user.

After receiving the data subscription elements, the computer application may output or otherwise send the data subscription elements to a database management system engine configured to manage one or more databases. In one implementation, the database management system engine may be coupled to various databases via various data connectors and may be stored on a network. As such, the database management system may installed upon or otherwise operate on a computing system. In any event, the database management system engine may continuously receive the data subscription elements from the computer application and continuously search various databases for data that correspond to the area of interest and the data set description of the data subscription elements.

Upon identifying data that correspond to the area of interest and the data set description, the database management system engine may tag the identified data as new data for the user (i.e., data recipient). In one implementation, the database management system engine may output or otherwise send the new data to the user in a format that is consistent with the data requirement. In another implementation, the database management system engine may output or otherwise send a notification to the user to indicate that new data is available for downloading. Such a notification may include text within a window generated by a operating system on a computing system, an e-mail, a text message, or another visual, aural, or vibratory notification.

Prior to sending the data subscription elements to the database management system, the computer application may also send data acceptance (i.e., synchronization) rules to the database management system engine, which may define conditions upon which new data should be sent to the user. As such, after identifying data that correspond to the area of interest and the data set description, the database management system engine may then determine whether the new data meets the acceptance rules. If the new data meets the acceptance rules, the database management system engine will output or otherwise send the new data to the computer application so that the user has access to the new data. Alternatively, if the new data does not meet the acceptance rules, the database management system engine will not output or otherwise send the new data to the computer application.

The following provides a brief description of various technologies and techniques for sending exploration and production data based on a data subscription. As mentioned above, the database management system engine receives the data subscription elements, which include an area of interest, a data set description and a data set requirement from a computer application. In response, the database management system engine may then identify data that correspond to the area of interest and the data set description in various data sources coupled to the database management system engine. Data sources may include databases, filesystems, webpages, web, applications and the like.

Upon identifying data that correspond to the area of interest and the data set description, the database management system engine may transform/translate the identified data into a format that matches the data set requirement. The transformation may be performed by a virtualization layer inside the database management system engine.

As mentioned above, the database management system engine may receive data acceptance (i.e., synchronization) rules for the new data from the computer application. The data acceptance rules may specify which of the new data should be sent to the user. As such, the database management system engine may send the identified data to the computer application based on the data acceptance (i.e., synchronization) rules. As a result of the processes described above, lean database management is achieved because time and/or energy are not wasted on data that is not important to the user.

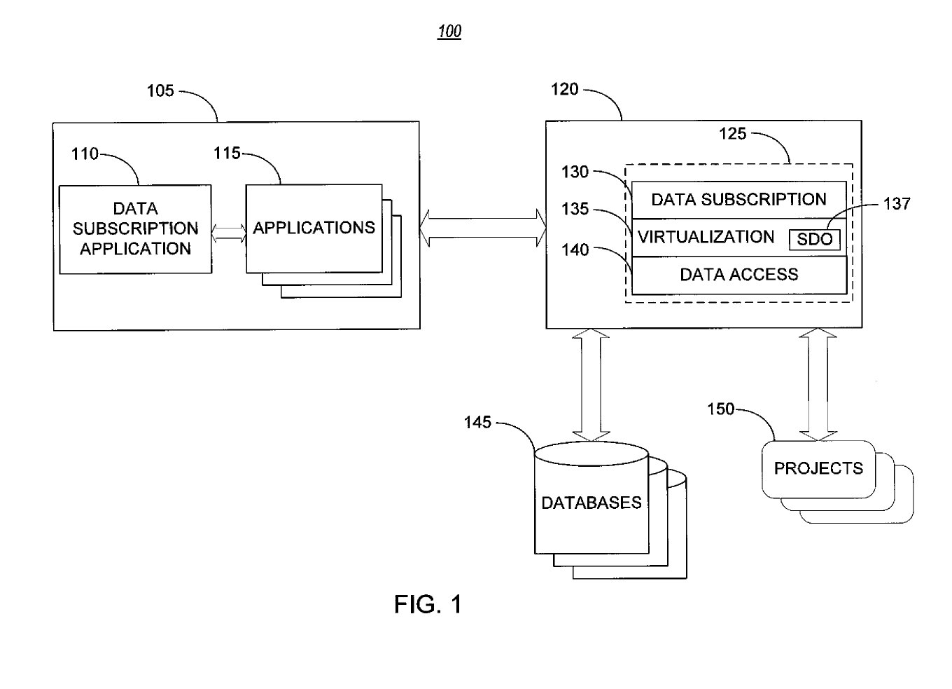

FIGS. 1-4 illustrate one or more implementations of various techniques for receiving and sending exploration and production data based on a subscription elements described herein in more detail.

FIG. 1 illustrates a schematic diagram of a database management system 100 in accordance with implementations of various techniques described herein. Database management system 100 provides exploration geoscientists and data managers a mechanism to easily find and visualize data within an area of interest from multiple data repositories. Database management system 100 may include client side machine 105 that is composed of data subscription application 110 and a variety of other applications 115. Database management system 100 may also include server side machine 120, which includes database management system engine 125. Database management system engine 125 may include a number of programming layers, such as data subscription layer 130, virtualization layer 135 and data access layer 140. Data access layer 140 may be configured to communicate with other devices outside server side machine 120. In one implementation, data access layer 140 may retrieve data stored on databases 145, projects 150 or both.

Databases 145 may include structured and unstructured databases that store exploration and production data that may be of interest to a user on client side machine 105. Exploration and production data stored on databases 145 may include data that is stored in non-homogeneous data repositories, data acquired using different workflows that have different data requirements, data that flows bi-directionally among many different repositories, data that enters the environment through many gates, and the like. Projects 150 may include various computer applications or files within a computer application that includes exploration and production data that may be relevant to a user.

Exploration and production data may include seismic reflection data, 3-D seismic data, seismic navigation data, raw seismic data, processed seismic data, interpreted seismic data, drilling data, well path data, well pick data, stratagraphic data, well header data, well completion data, raw well curve data, well curve data, processed well curve data, well test data, production network data, raw production data, consolidated production data, allocated production data, cultural data, geological models, reservoir models and the like.

Data subscription layer 130 may communicate with data subscription application 110 and allow users to enroll their interpretation projects into database management system 100. Interpretation projects may specify an area of interest, data set description and data set requirements for its data subscription. Based on the area of interest, data set description and data set requirements, the users may be able to obtain a current quality assessment of their interpretation project, along with any suggested data corrections.

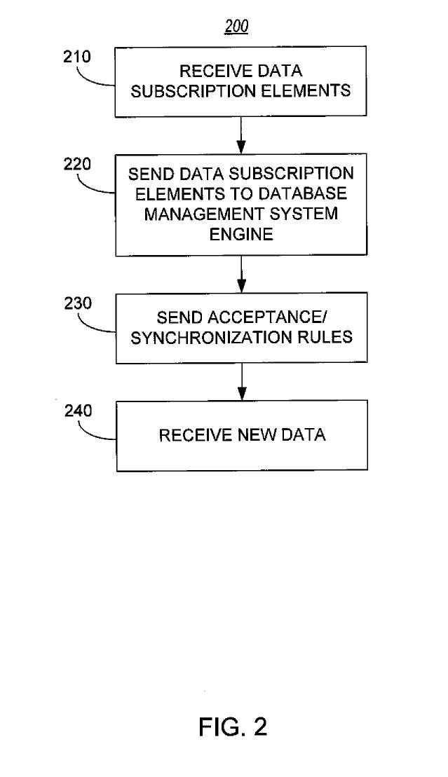

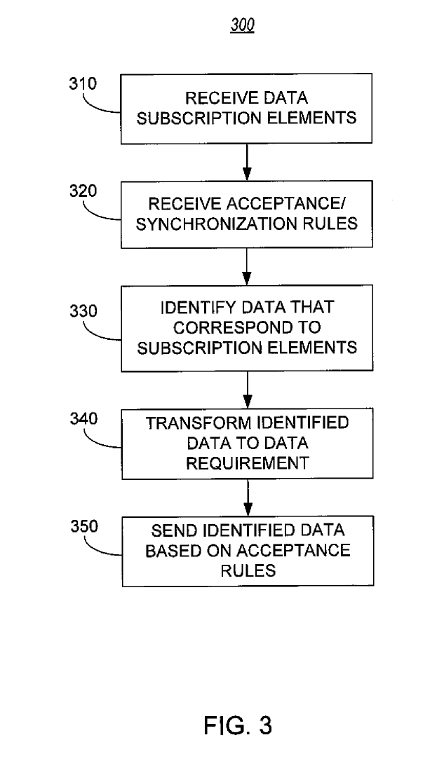

Starting with a new and empty interpretation project, users may define the data that they wish to receive according to their data set requirements. Updates to existing interpretation projects may either require notification and approval, or they may be done automatically based on the interpreter's preference. Additional details as to how users may subscribe to data are provided below with reference to FIGS. 2-3.

Virtualization layer 135 may be configured to translate between different workflow taxonomies to present the data to the user in a format in which the user can use. In one implementation, the translation may include transforming data as it moves between different applications and workflows. Currently this translation is performed using export-prepare-import scenarios that are heavily dependent on highly skilled data technicians or interpreters. In one implementation, virtualization layer 135 may use smart data objects 137 to provide rules and procedures for automatically translating the data. By using smart data objects 137, these error prone and tedious processes typically performed by technicians may become streamlined and semi-automated.

In one implementation, smart data objects 137 may include a unique resource identity, a dynamic object component, a set of input arguments or a set of dependent objects. By incorporating smart data objects 137 within virtualization layer 135, each smart data object 137 may have a unique resource locator (URL). The URL may provide a simple, yet extremely scalable and robust data access layer independent of computing platform, applications, and data source.

Smart data objects 137 may be an open platform that allows for third party plug-ins with regards to specific data translation requirements. Smart data objects 137 may follow one or more of the following rule methods: ObjectTypeChange, Merge, IdentityChange, ReParenting or ObjectCreation.

ObjectTypeChange may be configured to change a set of perforations to a perforation interval, a set of log curves to a deviation survey, or a set of log curves to a set of marker picks. Merge may be configured to change a collection of items to a single item (splicing of log curves). IdentityChange may be configured to rename a remarks field log curves and log sets. ReParenting may be configured to change the hierarchy of an object. For instance, a wellbore may belong to completions rather than the completion belonging to a wellbore, and wellbores may be re-parented to parent wellbores. ObjectCreation may be configured to create a well object from a set of wellbores, or a reservoir object from a set of completions.

In another implementation, virtualization layer 135 may also maintain a metadata catalog pertaining to the data. Metadata may be populated and cataloged based on metadata rules. Virtualization layer 135 may support the use of third party modules or scripts as part of the metadata creation.

In yet another implementation, virtualization layer 135 may also be configured to maintain a data audit catalog. As such, virtualization layer 135 may constantly check data sources for data changes. As data changes are detected, they can be configured to be stored in a data audit module. The participating data repositories and the frequency of auditing may be configured by the user. The data audit module may create an audit trail of all data transactions of an application which may include information pertaining to the data's origins (i.e., what application did the data start in, where has the data been), the data's owner (i.e., who created a marker pick, who edited the data), the data's updates (i.e., has the location changed), and the like. The data audit module may also create reporting options to export audit trails to various kinds of applications.

Data access layer 140 may be web-centric and may utilize a central XMLData Server, which may be similar to a HTTP server. The XMLData server protocol may be based on the HTTP protocol. The data acquired from database 145 or projects 150 may be rendered in a workflow dependent XML. The data may also be rendered in a workflow dependent taxonomy. In one implementation, application-specific and database-specific data drivers may be plugged into the XMLData server. These drivers may be open and may be developed or extended by third parties. The XML data server may support one or more of the following four data access API's: .NET, COM, CORBA or HTTP.

Although FIG. 1 indicates that database management system engine 125 includes three layers, it should be noted that in other implementations, database management system engine 125 may include additional layers. In one implementation, database management system engine 125 may also include a data quality layer. Data quality layer may be based on InnerLogix Data Quality Management technology, and may implement a Six Sigma rule-based quality engine. In one implementation, the data quality layer may break quality rules into one or more of the following five dimensions: completeness, consistency, content, uniqueness and validity. Data quality layer may operate based on a rule that utilizes trinary based arithmetic. The trinary based arithmetic may be based on whether a defect exists, a defect does not exist, or a defect may or may not exist.

In one implementation, the data quality layer may be integrated with virtualization layer 135 and may be able to thereby monitor virtualization layer 135 for data changes, yielding a near-real-time data quality system. The data quality layer may include rules that define how and when to handle detected defects. The rules may dictate that the data quality layer may automatically correct the defects based on a set of rules and conditions, assign the defects to a data manager for manual correction, or assign an approval list before either manual or automatic corrections for the defects are committed. In one implementation, the rules and the data correction process may be fully extensible using .Net, COM, or Java Script plug-ins.

Database management system engine 125 may also include a data query layer. In one implementation, querying data stores may require knowledge of the underlying structure of the data store. In this manner, virtualization layer 135 may normalize the querying process in a workflow centric manner such that each data store may be queried in the same manner. The queries may be based on the metadata layer and related n-dimensional indexes, which may allow for simple but very powerful query capabilities. For example, 2D GIS queries may be directly supported and 3D queries may also be enabled, e.g. “give me a list of intersecting wellbores.” Further, the metadata index may be designed for the creation of OLAP cubes that further enables a user to query and analyze the data in n-dimensional space.

Database management system engine 125 may also include a data reporting layer that is based on commercial reporting engines that utilize the standard data-binding interface of virtualization layer 135. The data reporting layer enables a full customization of the report generation process.

FIG. 2 illustrates a flow diagram of a method 200 for receiving exploration and production data based on data subscription elements in accordance with implementations of various techniques described herein. The following description of method 200 is made with reference to database management system 100 of FIG. 1. In one implementation, method 200 may be performed by data subscription application 110 of database management system 100. It should be understood that while method 200 indicates a particular order of execution of the operations, in some implementations, certain portions of the operations might be executed in a different order.

At step 210, data subscription application 110 may receive data subscription elements from a user. The data subscription elements may include an area of interest, a data set description and a data set requirement. The area of interest may describe geographical properties of the exploration and production data. For example, the area of interest may include specific geographical regions such as Gulf of Mexico, latitude/longitude coordinates, or specific data, such as wells that are located at least 10,000 ft below sea level. Area of interest may be a three dimensional location or described as a three dimensional location with time as a fourth dimension. An example of an area interest specified in the four dimensions may include a geographical region, such as the Gulf of Mexico, and time duration, such as January-February. In this manner, the user may be interested in exploration and production data obtained from the Gulf of Mexico region at any time between January and February.

In one implementation, the area of interest may be selected using a map based selection tool to create the boundaries of the area of interest. Alternatively, System Development Environment (SDE) layers within the data subscription application 110 may be used to select the area of interest using field boundaries or block boundaries, project boundaries, and the like. The area of interest may be saved for posting and future use. In one implementation, the area of interest may be posted on a map for reference.

The data set description (data type) describes the type of data that is related to the user's search. For example, the data set description may include raw log curves, work-station-ready log curves, data having production information, all data except those having production information, market picks, etc. The data set requirement may then be used to describe how the user would like the data to be prepared (i.e., format, units) for viewing and/or analysis. As data is moved between applications and different users, it often undergoes a number of changes or transformations such that the data is presented to the user as per the specified data set requirement. The transformations, however, are often undocumented and hidden away in scripts and manual processes. In one implementation, the transformations are used to modify data such that it “fits” a specific set of workflow. Using the example above, the data set requirement may include presenting the oil field data as production data per reservoir, normalized log curves, modified log curve names, spliced and de-spiked log curves, modified well names, perforated intervals and the like.

Previously, in order to perform the transformations described above, the user and a data manager would need a high level of skill such that they are familiar with the transformation process for any type of data set requirement. For instance, the transformation process often involve unit of measure conversions, noise removal and manual data entries. As such, the user and the data manager would need to know how to convert units, remove noise and add data entries to various types of exploration and production data. Further, the transformation process, as implemented by users or data managers, may introduce errors that may compromise the quality of the data and impact the resulting analyses. Additionally, implementing the transformation process using a user and a data manager is typically expensive to implement.

At step 220, data subscription application 110 may send the data subscription elements to database management system engine 125. As illustrated in FIG. 1, database management system engine 125 may be coupled to various databases via data access layer 140 which may include various data connectors. In one implementation, after receiving the data subscription elements, database management system engine 125 may continuously search various databases for data that correspond to the area of interest and the data set description. Upon identifying exploration and production data that correspond to the area of interest and the data set description, database management system engine 125 may tag the identified exploration and production data as new data for the user.

At step 230, data subscription application 110 may send data acceptance (i.e., synchronization) rules to database management system engine 125. In one implementation, the data acceptance rules may define conditions upon which new data should be sent to the user. For instance, the user may wish to receive new data if the new data differs from its current data by more than a predetermined percentage. In this manner, database management system engine 125 may determine whether the new data meets the data acceptance rules and send the data to the user if the new data meets the data acceptance rules. In another implementation, the acceptance rules may define how the user may be notified about the new data. For instance, the user may request for notifications to be sent for automated data changes in the application, updates or new data. The user may also specify how it should be updated (e.g., via application activity log, via email). The data acceptance rules may also define a level quality for the new data or based on where the data originated (i.e., application or user name). Although method 200 is described as having step 230, it should be noted that in some implementations step 230 is not required for method 200. In such a scenario, method 200 may continue at step 240.

At step 240, data subscription application 110 may receive the new data from database management system engine 125 according to the data requirement. As mentioned above, the data set requirement may describe how the user prefers the data to be prepared (i.e., format, units) for viewing and/or analysis. As such, database management system engine 125 may transform the identified data into a format as specified by the data requirements. Database management system engine 125 may also send a notification to the user that indicates that new data is available for download.

In one implementation, data subscription application 110 may provide a user interface for its user to facilitate the creation and display of area of interests for the subscriptions. The user interface may also provide a list view of new data pulled into the user's application, color coded notification maps of new or edited data, a preview of selected individual data items, such as a well log previewer.

In another implementation, data subscription application 110 may include advanced visualization features, such as base map capabilities, well data viewer capabilities and data manager visualization tools. Base map capabilities may include SDE based map, cross section creation, bubble map posting for various attributes stored in multiple data stores, advanced regional gridding and contouring, advanced reporting tools, scaled plotting and map annotations. Well data viewer capabilities may include advanced well data displays with associated data types in a single display that include log curves, special and conventional core data and flow tests.

Data manager visualization tools may include charts and graphs for data transactions, charts and graphs for quality of data, mapping of well data with known quality tagging, charts and graphs for data quantity, displaying volumes in data stores of data objects, all reporting, graphs, and charts exportable to various types of applications. Data manager visualization tools may also include administration and management tools for the user. Administration tools may include user administration and system administration tools. User administration tools may be used to setup new users and define what the new users are authorized to access. System administration tools may include subscription management tools that define sources for subscriptions. System administration tools may also include metadata management tools (taxonomy and workflows) to update taxonomy of the domain objects and their mapping on data sources.

Some management tools may include reporting management, rules management, transaction management and index management. Reporting management may define reports. Rules management may include rules automation to define rules to use for data translation during transfers and rules subscription to define logic and evaluation criteria for new data. Transaction management may include managing volume which may define data profiling criteria and what data is being used the most, transaction tracking which may define which transactions (i.e., create, update, delete) to track, and audit tracking which may define and report users that have updated data (i.e., Create, Update, Delete). Index management may define the data sources to index and the frequency of indexing.

Additional details related to the database management system engine 125 are provided below with reference to FIG. 3.

FIG. 3 illustrates a flow diagram of a method 300 for sending exploration and production data based on data subscription elements in accordance with implementations of various techniques described herein. The following description of method 300 is made with reference to database management system 100 of FIG. 1 and method 200 of FIG. 2. In one implementation, method 300 may be performed by database management system engine 125 of database management system 100. It should be understood that while method 300 indicates a particular order of execution of the operations, in some implementations, certain portions of the operations might be executed in a different order.

At step 310, database management system engine 125 may receive the data subscription elements (i.e., from step 220) which include the area of interest, the data set description and the data set requirement from data subscription application 110. In one implementation, data subscription layer 130 may receive the data subscription elements.

At step 320, database management system engine 125 may receive data acceptance/subscription rules from data subscription application 110 (i.e., step 230). However, as mentioned above with regard to step 230, in some implementations, method 300 may be performed without step 320.

At step 330, database management system engine 125 may identify data that correspond to the area of interest and the data set description in various data sources coupled to the database management system engine. Data sources may include databases, filesystems, webpages, the Web, applications and the like. In one implementation, database management system engine 125 may crawl through each data source to locate exploration and production data that corresponds to the area of interest and the data set description as defined in the data subscription elements. In one implementation, exploration and production data may be identified in a data access layer that includes an XML based Data server having a central index repository.

In one implementation, while searching through the various data sources, database management system engine 125 may build a metadata index that indicates some information about the various data sources and the data acquired from the data sources. The information stored in the metadata index may include information landscape, which describe how data and information are managed within an organization. There may be at least two landscapes within an organization: the designed landscape and the actual landscape. The designed landscape may describe how data should work, and the actual landscape may describe how end-users manage the data. Information landscape may also include a unified landscape, which combines the designed landscape and the actual landscape.

The information landscape may describe data repositories, such as its roles, owners, requirements, data and the like. The information landscape may also describe the flow between data repositories, such as data requirements and timeliness. The information landscape may also describe activities, such as event triggers, description of activity and activity owner.

As data is moved between data repositories, there may be specific processes that are applied to the data. These processes may control when data is moved, what data is moved, how data is modified during the move or when data is deleted. Database management system engine 125 may convert the processes into data normalization rules and data integration rules.

At step 340, database management system engine 125 may transform or translate the identified data that correspond to the area of interest and the data set description into a format that matches the data set requirement. In one implementation, the transformation may take place in virtualization layer 135 inside database management system engine 125. The transformation described at step 330 may be configured to enable just-in time data. Just-in-time data includes sending data that is requested as opposed to sending all of the available data. In conventional systems, most database management systems push data to its recipients. That is, the transfer of data is controlled by its sender. The data sender does not know what data the user (i.e., data recipient) requires. As such, the data sender sends all of the data to the user or from one data store to another, and the conventional systems may store all of the pushed data in a central repository as opposed to data that has been requested by a user (i.e., just-in-time data).

Some of the problems related to the conventional database management system include managing all of the data in the same manner even though only a small fraction of the data is being used, thereby wasting management processing time and energy on irrelevant data. For instance, an organization may only utilize 10% of the data that is under active management, but the vast majority of the information technology resources are wasted on data and information that is currently not contributing toward the end goal, e.g., profits. Another problem may include how data sharing is accomplished by using export/import workflows that are heavily dependent on highly skilled workers who are capable of transforming data into formats that are usable by the users. Yet another problem may include having multiple versions of the relevant data on different applications and databases.

Other issues may include managing different data hierarchies, different data definitions or different data access methods. Another obstacle may be that data repositories may not share the same data hierarchy and data grouping (Data Taxonomy), and often may not share the same data object definitions. Even among “identical” repositories, data taxonomies and data object definition may be different due to specific workflow needs of different users. For instance, some workflows may require perforations and bridge plugs to be treated as marker picks.

By enabling just-in-time data, database management system 125 may resolve some of the problems associated with the conventional inefficient database management system.

In one implementation, virtualization layer 135 may normalize the identified data to execute a quality assessment process between two or more data repositories.

A part of this normalization may involve with taxonomy and data object normalization. In one implementation, the normalization process may utilize the information obtained during the development of the information landscape. Based on this information, virtualization layer 135 may assign each specific repository to a specific taxonomy and data object classification (TDOC). Additionally, virtualization layer may assign each data integration process a TDOC such that each process may be defined as part of a TDOC Matrix.

A part of the TDOC process may include the construction of Smart Data Objects (SDOs) 137. For data repositories that do not support a specific data object, the processes may apply SDOs to automatically construct a specific data object. For example, for wellbore centric repositories participating in a well centric data quality management process, a well-SDO may be utilized to create the well object for these repositories.

SDOs may also be useful in the dynamic implementation of the data integration processes. These processes may include allocating production volumes to formation rather than completions, splicing log curves and deviation surveys or de-spiking log curves.

Additionally, by utilizing SDOs, virtualization layer 135 may dramatically reduce the complexity of the data integration/translation problem. Each SDO may have an assigned globally unique identifier (GUID) that allows the integration process to track usage and dependencies of specific SDOs, thereby allowing for the automatic updates of an SDO when it is instantiated. This may dramatically reduce the need for unnecessary data copying and synchronization. For example, smart data objects 137 in interpretation packages may store the input references along with an associated integration algorithm. When the interpretation package asks for the data, the virtualization layer may regenerate the data using the input references and the integration algorithm. This design may ensure that the smart object never becomes out of synch.

In one implementation, SDO's may store the source of the input data (i.e., Uniform Resource Locator) along with any normalization processes. When the data is requested, virtualization layer 135 may use SDOs to automatically regenerate the data. For example, each SDO may be assigned a globally unique resource identifier, URI, along with a unique resource locator, URL.

In another implementation, Data Object Servers (DOS) may be utilized by data access layer 140 along with the URL to access data. The DOS may be very similar to a HTTP server, and may support several protocols, including DOOM, HTTP, .NET or CORBA. The protocols may support the following methods: Get(URL), Put(URL,xmlDataObject), Add(URL,xmlDataObject) or Delete(URL).

The DOS may allow applications to directly integrate with data using an HREF concept, which specifies the destination of an HTML link. This enables the information landscape to move toward a “web” type infrastructure rather than a hub-and-spoke infrastructure. The DOS further allows for a reduction in the number of repositories, thereby eliminating waste.

By utilizing a just-in-time data delivery service, database management system engine 125 may eliminate the need for enabling quality control application and cleansing all data objects.

At step 350, data subscription layer 130 may send identified data based on data acceptance (i.e., synchronization) rules, received at step 320, to the end user. In one implementation, database subscription layer 130 may send a notification to the user that indicates that new data is available for download.

By using methods 200 and 300, database management system 100 may create a robust environment to transfer data from multiple data repositories to end users' project databases. As a result, database management system 100 allows for the expansion and customization of various applications such that they may more easily integrate with new data sources and applications in the future.

Database management system 100 may create an environment that may be able to achieve one or more of the following:
Significantly increase productivity of exploration geoscientist and database management teams and processes by reducing the time spent in achieving ready-to-analyze data
Support access to multiple data repositories and increased predictability of data flows
Enable a high quality data environment for accurate decision making
Provide a continuous process for elimination of “waste” in Information Management (IM)
Facilitates scalability and customization for evolving Information Management needs

By subscribing to data using the database management system 100, a user may be able to select data types from multiple data stores to receive data of known quality automatically.

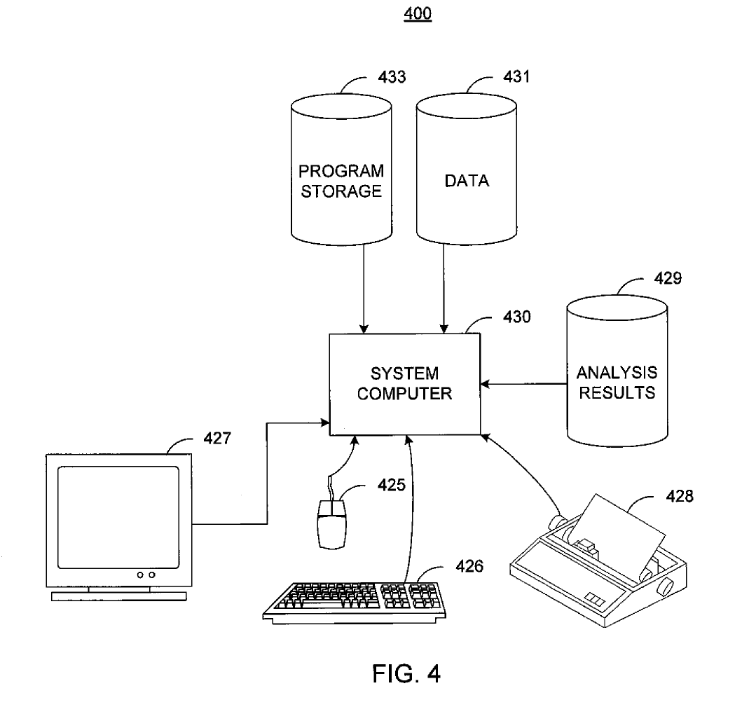

FIG. 4 illustrates a computer network 400 into which implementations of various technologies described herein may be implemented. The computing system 400 (system computer) may include one or more system computers 430, which may be implemented as any conventional personal computer or server. However, those skilled in the art will appreciate that implementations of various techniques described herein may be practiced in other computer system configurations, including hypertext transfer protocol (HTTP) servers, hand-held devices, multiprocessor systems, microprocessor-based or programmable consumer electronics, network PCs, minicomputers, mainframe computers, and the like.

The system computer 430 may be in communication with disk storage devices 429, 431, and 433, which may be external hard disk storage devices. It is contemplated that disk storage devices 429, 431, and 433 are conventional hard disk drives, and as such, will be implemented by way of a local area network or by remote access. Of course, while disk storage devices 429, 431, and 433 are illustrated as separate devices, a single disk storage device may be used to store any and all of the program instructions, measurement data, and results as desired.

In one implementation, exploration and production data may be stored in disk storage device 431. The system computer 430 may retrieve the appropriate data from the disk storage device 431 according to program instructions that correspond to implementations of various techniques described herein. The program instructions may be written in a computer programming language, such as C++, Java and the like. The program instructions may be stored in a computer-readable medium, such as program disk storage device 433. Such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the system computer 430. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

In one implementation, the system computer 430 may present output primarily onto graphics display 427, or alternatively via printer 428. The system computer 430 may store the results of the methods described above on disk storage, for later use and further analysis. The keyboard 426 and the pointing device (e.g., a mouse, trackball, or the like) 425 may be provided with the system computer 430 to enable interactive operation.

The system computer 430 may be located at a data center remote from where data may be stored. The system computer 430 may be in communication with various databases having different types of data. These types of data, after conventional formatting and other initial processing, may be stored by the system computer 430 as digital data in the disk storage 431 for subsequent retrieval and processing in the manner described above. In one implementation, these data may be sent to the system computer 430 directly from the databases. In another implementation, the system computer 430 may process data already stored in the disk storage 431. When processing data stored in the disk storage 431, the system computer 430 may be described as part of a remote data processing center. The system computer 430 may be configured to process data as part of the in-field data processing system, the remote data processing system or a combination thereof. While FIG. 4 illustrates the disk storage 431 as directly connected to the system computer 430, it is also contemplated that the disk storage device 431 may be accessible through a local area network or by remote access. Furthermore, while disk storage devices 429, 431 are illustrated as separate devices for storing input data and analysis results, the disk storage devices 429, 431 may be implemented within a single disk drive (either together with or separately from program disk storage device 433), or in any other conventional manner as will be fully understood by one of skill in the art having reference to this specification.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for managing oil field data based on one or more subscription elements, comprising:
receiving the subscription elements having an area of interest, one or more data types and one or more dataset requirements, wherein the area of interest comprises one or more geographical properties that correspond to the oil field data, and wherein the dataset requirements define how the oil field data is to be presented;
identifying the oil field data that corresponds to the area of interest and the data types;
transforming the identified oil field data to one or more formats based on the dataset requirements; and
outputting the transformed oil field data.

2. The method of claim 1, further comprising receiving one or more conditions that define when the oil field data should be sent.

3. The method of claim 2, wherein outputting the transformed oil field data comprises outputting the transformed oil field data when the identified oil field data differs from a previous version of the oil field data by a predetermined percentage.

4. The method of claim 1, wherein the identified oil field data is transformed using one or more smart data objects that provide one or more rules and one or more procedures for transforming the identified oil field data into the formats.

5. The method of claim 4, wherein the smart data objects comprise a unique resource identity, a dynamic object component, a set of input arguments, a set of dependent objects or combinations thereof.

6. The method of claim 1, wherein identifying the oil field data comprises crawling through one or more data sources for oil field data that are located in the area of interest and correspond to the data types.

7. The method of claim 6, further comprising building a metadata index for each data source, wherein the metadata index comprises information pertaining to the data sources and one or more data in the data sources.

8. The method of claim 6, further comprising:
detecting one or more changes in the oil field data in the data sources; and
storing the changes in a data audit module.

9. The method of claim 8, wherein the data audit module creates an audit trail of the changes.

10. The method of claim 8, further comprising:
detecting one or more defects in the changes; and
automatically correcting the defects.

11. The method of claim 10, wherein the defects are detected in a data quality layer.

12. The method of claim 6, further comprising normalizing the identified oil field data based on the data sources.

13. The method of claim 1, wherein the identified oil field data is transformed by:
changing a set of perforations to a perforation interval;
changing a set of log curves to a deviation survey;
changing a set of log curves to a set of marker picks;
changing a collection of the oil field data to a single oil field datum;
changing a hierarchy of the oil field data; or combinations thereof.
